(19) United States
(12) Patent Application Publication
(10) Pub. No.: US 2011/0320493 A1
(43) Pub. Date: Dec. 29, 2011

(54) METHOD AND DEVICE FOR RETRIEVING DATA AND TRANSFORMING SAME INTO QUALITATIVE DATA OF A TEXT-BASED DOCUMENT

(75) Inventor: Julien LEMOINE, BEZONS (FR)

(73) Assignee: THALES, NEUILLY SUR SEINE (FR)

(21) Appl. No.: 13/226,225

(22) Filed: Sep. 6, 2011

Related U.S. Application Data
(63) Continuation-in-part of application No. 12/161,600, filed on Feb. 24, 2009.

(30) Foreign Application Priority Data
Jan. 20, 2006 (FR) 06 00537

(51) Int. Cl. G06F 17/30

(52) U.S. Cl. 707/776; 707/E17.014

(57) ABSTRACT

Method for extracting information from a data file comprising a first step wherein the data are transmitted to a device (3.1) or “tokenizer” adapted to convert them in the course of a first step into elementary units or “tokens”, the elementary units being transmitted to a second step of searching in the dictionaries (3.2) and a third step (3.3) of searching in grammars, wherein, for each conversion step, a sliding window of given size is used, the data are converted into “tokens” as and when they arrive in the tokenizer and the tokens are transmitted as and when they are formed to the step of searching in dictionaries (3.2), then to the step of searching in the grammars (3.3).

### CROSS-REFERENCE TO RELATED APPLICATIONS

The present Application is a Continuation-In-Part of U.S. application Ser. No. 12/161,600, filed Jul. 21, 2008, which is based on International Application No. PCT/EP2007/050569, filed Jan. 19, 2007, which in turn corresponds to French Application No. 06 00537, filed Jan. 20, 2006, the disclosures of which are hereby incorporated by reference herein in their entireties.

### FIELD OF THE INVENTION

The invention relates notably to a method for extracting information and for transforming it into qualitative data of a textual document.

### BACKGROUND OF THE INVENTION

It is used notably in the field of the analysis and the comprehension of textual documents.

In the description, the word “token” denotes the representation of a unit by a bit pattern and “tokenizer” denotes the device adapted for perform this conversion.

In the presence of unstructured documents, for example texts, the problem posed is to extract the relevant item of information while managing the complexity and ambiguities of natural language.

Today, information streams are increasingly present and their analysis is necessary if one wishes to improve the productivity and speed of reading of texts.

Several extraction procedures are known in the prior art. For example, the procedure used by AT&T, an example of which is accessible via the Internet link http://www.research.att.com/sw/tools/fsm/, the procedure developed by Xerox illustrated on the Internet link http://www.xrce.xerox.com/competencies/content-analysis/fst/home.en.html and the procedure used by Intex/Unitex/Nooj illustrated on the link http://www-igm.univ-mlv.fr/˜unitex/.

However, all these techniques have the drawbacks of not being sufficiently flexible and efficacious, since the stress has been placed on the linguistic aspect and on the power of expression, rather than on the industrial aspect. They do not make it possible to process significant streams in a reasonable time while preserving the quality of analysis.

The object of the invention relies notably on a novel approach: a window size is chosen for each processing of the method, the “tokens” are processed one by one, the token arriving in the form of a stream, this being followed by the processing one following another, each one using its own window (for example, the dictionary search or in transducers provided by one grammar).

One subject of the present invention relates to a method for extracting information from a data file comprising a first step wherein the data are transmitted to a device or “tokenizer” adapted to convert them in the course of a first step into elementary units or “tokens”, the elementary units being transmitted to a second step of searching in the dictionaries and a third step of searching in grammars changed into a transducer or an automaton, characterized in that, for each step of conversion, a sliding window of given size is used, the data are converted into “tokens” as and when they arrive in the tokenizer and the tokens are transmitted as and when they are formed to the step of searching in dictionaries, then to the step of searching in the grammars.

The subject of the present invention offers notably the following advantages:
the architecture makes it possible to avoid duplication of data and to use several grammars in parallel or in series without any intermediate result,
on account of the speed of the procedure implemented, it is possible to apply a multitude of complex grammars and therefore to extract a large amount of information from the documents without degrading the linguistic models,
the architecture innately manages the priority of the grammars, thereby making it possible to define “tiered models”.

Still other objects and advantages of the present invention will become readily apparent to those skilled in the art from the following detailed description, wherein the preferred embodiments of the invention are shown and described, simply by way of illustration of the best mode contemplated of carrying out the invention. As will be realized, the invention is capable of other and different embodiments, and its several details are capable of modifications in various obvious aspects, all without departing from the invention. Accordingly, the drawings and description thereof are to be regarded as illustrative in nature, and not as restrictive.

### BRIEF DESCRIPTION OF THE DRAWINGS

The present invention is illustrated by way of example, and not by limitation, in the figures of the accompanying drawings, wherein elements having the same reference numeral designations represent like elements throughout and wherein:

FIG. 1, a functional diagram of the general operation of the processing chain in the field of document analysis,

FIG. 2, a functional diagram of the processing which can be performed in a processing chain,

FIG. 3, a functional diagram of the method according to the invention making it possible to extract entities, relations between these entities, and to convert documents into digital data,

FIG. 4, an exemplary transducers for converting a code (grammatical, flexional, semantic or syntactic) into integer,

FIG. 5, an automaton making it possible to recognize a series of integers representing the codes (grammatical, flexional, semantic and syntactic) defined in FIG. 4,

FIG. 6, a method for constructing an optimal sub-dictionary for a set of grammars on the basis of an original dictionary,

FIG. 7, a method for deleting the empty transitions in a transducer,

FIG. 8, an exemplary automaton for illustrating the method of FIG. 7,

FIG. 9, the output of the method of FIG. 7 applied to the automaton of FIG. 8,

FIG. 10, a transducer representing a set of lemmas and inflected forms before separation into two transducers, output of these transducers being not shown on this figure,

FIG. 11, the transducers whose the input of the alphabet consists un alpha-numerical characters representing lemmas of FIG. 10, output of these transducers being not shown on this figure,

FIG. 12, the transducers whose the alphabet on the input consists on alpha-numerical characters representing inflected forms of FIG. 10, output of these transducers being not shown on this figure,

FIG. 13, the steps of a method making it possible to calculate the successor nodes of a node of the automaton on the basis of an entry,

FIG. 14, a use of the rewrite and extraction grammars,

FIG. 15, a method of detecting the identified set of tokens in an automaton or transducer,

FIG. 16, a method of updating the set of potentially identified tokens, this method is used by the method of FIG. 15,

FIG. 17, the management of the priority between two transducers provided from grammars G1 and G2 (G2 taking priority over G1) via a procedure for scoring or selecting the set of identified tokens of higher priority when there is overlap,

FIG. 18, the management of disambiguation when there is an overlap between an extraction grammar and a disambiguation grammar, and

FIG. 19 an exemplary application of the method according to the invention in respect of a messaging server.

### DETAILED DESCRIPTION OF THE INVENTION

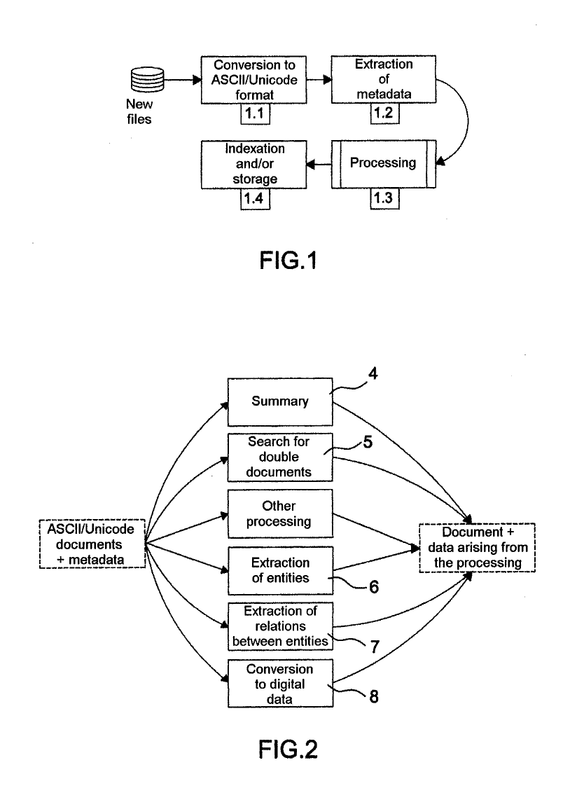

FIG. 1 represents a general processing chain for analyzing documents. In the majority of cases, this chain comprises, for example:

an element intended to convert any entry format to a text format, block 1.1,

a module for extracting meta-data such as the date, the author, the source, etc., block 1.2,

a module for processing these documents, block 1.3,

an indexation module, block 1.4, for searches and subsequent uses.

The method according to the invention lies more particularly at the level of the processing block 1.3.

In FIG. 2 are illustrated examples of conventional processing operations such as the summarizing of documents, 4 or the search for double documents, 5.

The function of the method according to the invention is notably to perform the following processing operations:
the extraction of entities 6: for example the extraction of persons, facts, gravity of a document, feelings, etc.
the extraction of relations 7 between the entities: for example, relations between dates and facts, between persons and facts, etc.
the conversion 8 of a document into a set of digital data for a subsequent processing such as automatic classification, knowledge management, etc.

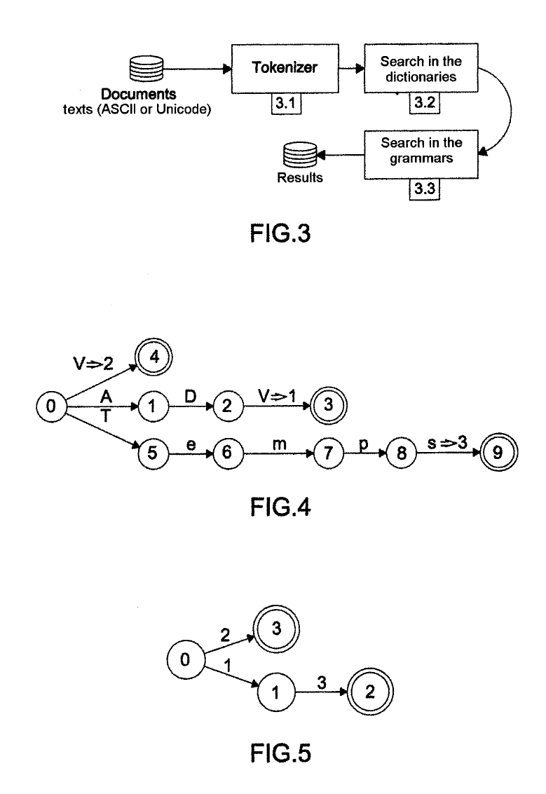

To perform these processing operations, a set of documents is used, for example, in the form of ASCII or Unicode files or memory areas. The method for transforming a text described in FIG. 3 is then applied, this decomposing notably into 3 principal steps:

1) splitting of a source document into a set of elementary units or “tokens”, by a device or “Tokenizer”, 3.1, suitable for converting a document into elements,

2) recognition of the simple and compound units, 3.2, present in the dictionaries,

3) applications of grammars, 3.3.

### Step 3.1

The method according to the invention uses a sliding window of units, that is to say it preserves only the last X “tokens” of the text (X being a fairly large number since it determines the maximum number of units which will be able to be rewritten by a transducer). The size of the sliding window is chosen at the beginning of the method.

During the step of converting the data into “tokens”, the tokenizer 3.1 converts the data as and when they are received before transmitting them in stream form to the step of searching in a dictionary, 3.2.

The types of “tokens” are for example:
space: carriage return, tabulation, etc.
separator: slash; parentheses; square brackets; etc.
punctuation: comma, semicolon, question mark, exclamation mark, etc.
number only: from 0 to 9,
alphanumeric: set of alphabetic characters (dependent on the language) and numbers,
end of document.

The “tokenizer” 3.1 is provided, for example, with a processor suitable for converting a lowercase character into an uppercase character and vice versa, since this depends on the language.

As and when they are output from the “tokenizer”, 3.1, the “tokens” are transmitted gradually to the step of searching in the dictionaries, 3.2.

### Step 3.2, the Search in the Dictionaries

The dictionaries 3.2 consist of entries composed notably of the following elements:
an inflected form,
a lemma,
a grammatical label or “tag”,
a set of flexional codes,
a set of semantic codes,
a set of syntactic codes.

The dictionary 3.2 is, for example, a letter-based automaton each node of which possesses linguistic attributes and may or may not be final. A node is final when the word is completely present in the dictionary.

The “tokens” are transmitted to the module for searching the dictionaries 3.2 in stream form, that is to say they arrive one after another and are processed in the same manner one after another by the module 3.2. For each “token”, the module checks to verify whether it does or does not correspond to a dictionary entry.

In the case where a “token” corresponds to a dictionary entry, then the method processes the following two cases:
either the corresponding node of the transducer is a final node: in this case the dictionary entry is added to the “token” sliding window, as is the position of the “token” and of the node of the transducer to a list so as to identify a potential compound entity,
or the node is not a final node, in this case, the position of the “token” is just an addition to identify a potential compound entity.

In the second case, it is not yet known whether the entry is or is not a compound entity of the dictionary, since it corresponds only to the beginning (for example “pomme” is received which corresponds partially to the compound entity “pomme de terre”). If the continuation, “de terre”, is received later, then the compound entity has been detected, otherwise the potential entity is deleted since it is not present. When the window of tokens is filled, the oldest token is transmitted to the following step and so on.

An option of the search in the dictionaries makes it possible to specify that the lowercase characters in the dictionary can correspond to an uppercase or lowercase character in the text. On the other hand, an uppercase character in the dictionary can correspond only to an uppercase character in the text. This option makes it possible notably to take into account poorly formatted documents such as, for example, a text fully in uppercase (often encountered in old databases).

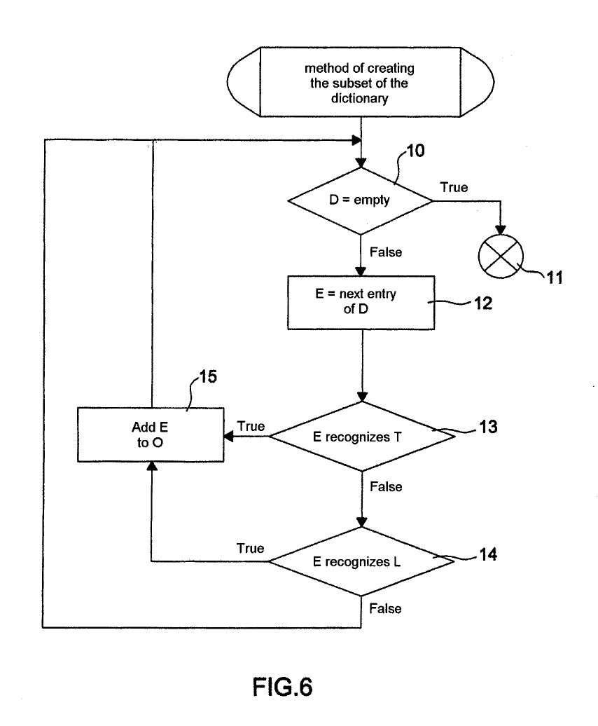

According to a variant embodiment of the method and with the aim of optimizing the search times, the method constructs a subset of the dictionary during compilation of the latter. An exemplary implementation of steps is given in FIG. 6.

The method recovers all the transitions of the transducers provided by the compilation of the grammers which refer to the dictionary (lemmas, grammatical codes, etc.). All these transitions are compiled and all the dictionary entries which correspond at least to one of these transitions are selected.

For example, if a grammar contains only the transitions <ADV(adverb)+Time> and <V> as referring to the dictionary, only the entries of the dictionary which are verbs or adverbs with Time as semantic code will be extracted.

The process for compiling the transitions into a transducer comprises for example the following steps:
the first step consists in extracting, from all the transducers used and obtained by the compilation of grammars, the set of grammatical, semantic, syntactic and flexional codes contained in each of the transitions of the grammars, and
during a second step, a letter-based transducer whose the alphabet in input is composed of alpha-numerical characters which associates a unique integer with each code.

Each set of codes therefore consists of a set of integers that are ordered from the smallest to the largest and that are inserted into an integer-based transducers so as to determine whether or not this code combination is present in the graphs.

If, for example, the grammars contain the codes ADV+Time and V, then this is the transducer which transforms the codes into integer of FIG. 4.

Said transducer converts:
the character string “ADV” into an integer value: 1
the character string “V” into an integer value: 2
the character string “Time” into an integer value: 3

Once the transducer converting the codes into integer has been constructed, the second automaton representing the transitions is constructed (FIG. 5). On this automaton, the transition ADV+Time is represented by node 2 and the transition V by node 3.

Similarly, an automaton using as alphabet in input alpha-numerical characters is constructed for the set of lemmas used in the grammars. The lemmas being text, it is easy to contemplate the conversion in an automaton whose the alphabet consists in letters.

In detail, the diagram of FIG. 6 illustrates the construction of an optimal sub-dictionary. It comprises for example the following steps: for each entry E of the dictionary D, 10, 12, a check, 13, is made to verify whether E identify the automaton T representing the transitions or, 14, the automaton L containing the lemmas. If this is the case, E is added, 15, to the sub-dictionary O. This process is repeated for all the entries of the dictionary D.

By this dictionary pruning, the smallest possible dictionary is constructed for a given application, thereby making it possible to gain in performance on most grammars.

The elements arising from the dictionary search step are transmitted one by one and in stream form to the step of applying the grammars, an example of which is detailed hereinafter. The searching step in a dictionary comprising a window, the tokens are transmitted with a shifting corresponding to the size of the window.

Step 3.3, application of the grammars to the elements arising from the step of searching the dictionaries.

Advantageously, the method implements grammars which have been compiled.

### Compilation of the Grammars

Before even being able to use the grammars in the method according to the invention, a compilation of said grammer with a transducer shape is performed which can be decomposed into two steps:

The deletion of the empty transitions,

The decomposition of the transitions into automaton whose the input alphabet consists on letters.

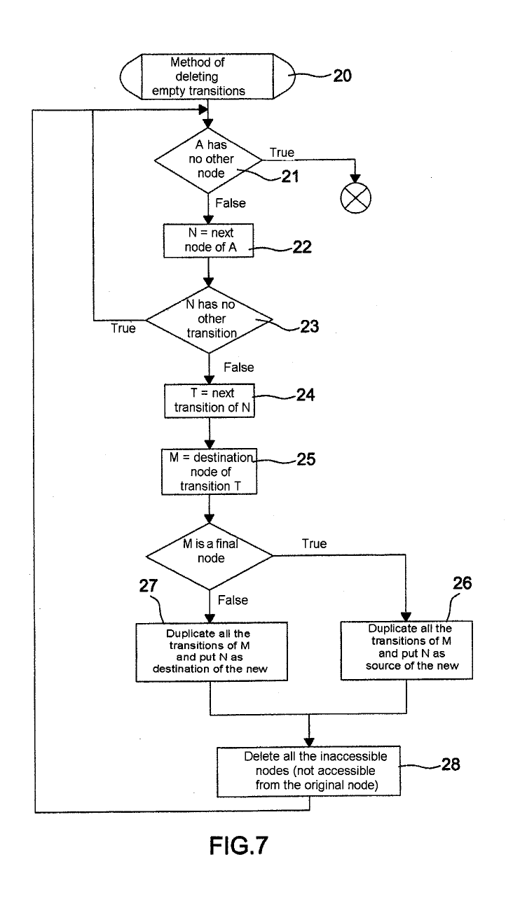

FIG. 7 describes an exemplary series of steps making it possible to delete the empty transitions of an automaton, 20.

For all the nodes N of the automaton A, 21, for all the transitions T from node N to a node M. If the transition T is an empty transition and M is a final node, then T is deleted, 26, and all the transitions which have M as starting nodes are duplicated while putting N as new starting node (the destination node is not changed). If the transition T is an empty transition and M is a non-final node, then T is deleted and all the transitions which have N as destination node are duplicated, 27 while putting M as new destination node (the source node is not changed). All the inaccessible nodes, 28, not accessible by the original node are deleted.

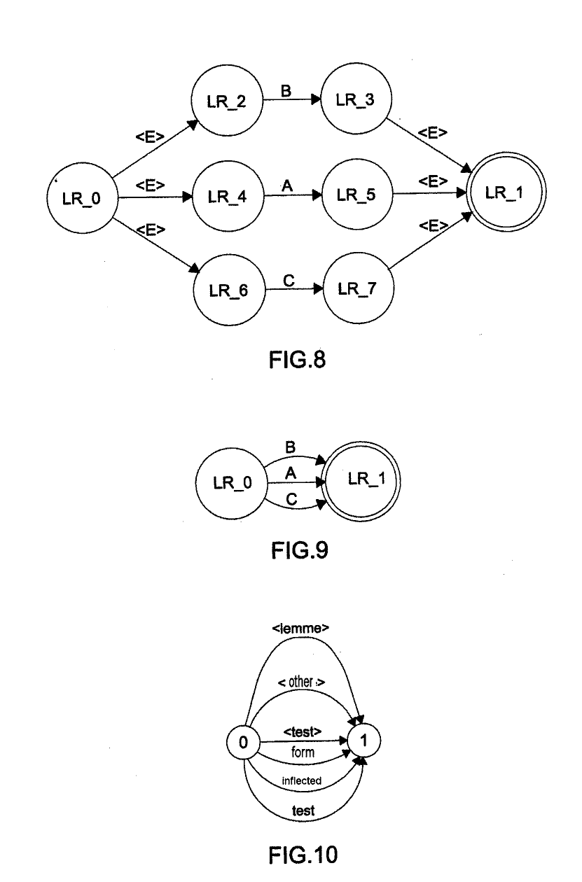

FIGS. 8 and 9 show diagrammatically an automaton on which the method described in conjunction with FIG. 7 is applied and the result obtained. This modification of the automaton makes it possible to simplify the traversal thereof since the empty transitions are always ‘true’ and must always be traversed. The second step consists in transforming the set of lemmas and the set of inflected forms, contained in the transitions of the automaton into two new transducers whose the input alphabet consists on letters so as to speed up the searches for subsequent nodes.

For example, the transitions from node 0 to 1 in FIG. 10 contain a set of lemmas and inflected forms. The outputs of these transducers are not shown on the figure. These outputs are integers whose meaning is explained below.

A conventional search ought therefore to scan the whole set of these transitions to detect those which may correspond to the entry received.

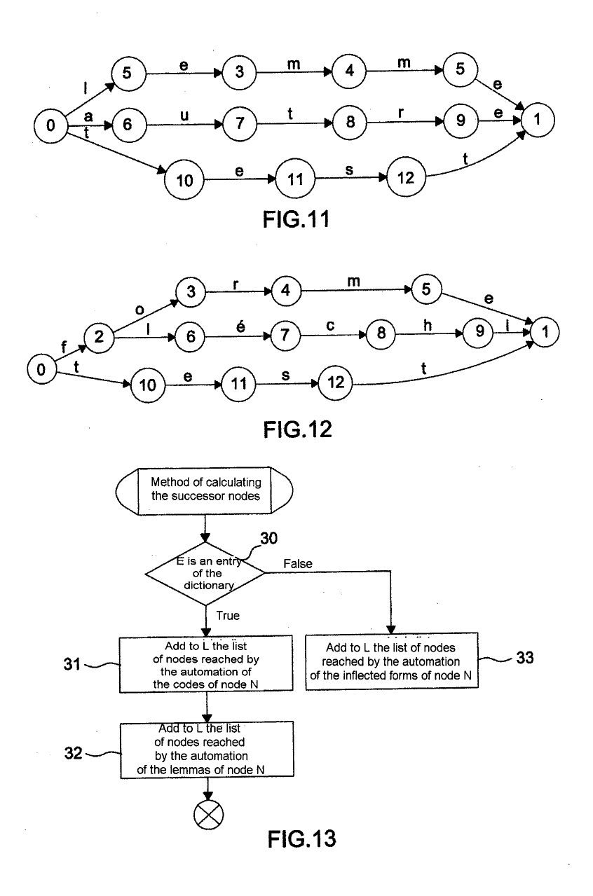

The transformation of this set of lemmas and inflected form gives two transducers:
the first transducer contains only the lemmas, that is to say “lemma”, “other” and “test” as shown by FIG. 11. The outputs of these transducers are not shown on the figure. These outputs are integers whose meaning is explained below.
the second transducer contains only the inflected forms, that is to say “form”, “inflected” and “test” as shown by the transducer of FIG. 12. The outputs of these transducers are not shown on the figure. These outputs are integers whose meaning is explained below.

In the method according to the invention, a transition from a node to N other nodes is defined notably by a set of three transducers whose the output alphabet consists on letters:
the transducer of the lemmas,
the transducer of the inflected forms,
the transducer of the grammatical, syntactic, semantic and flexional codes.

Each of these transducer returns an integer. If there is a recognition, this integer is in fact an index of an array in which the set of subsequent nodes of automaton A accessible by this state is stored.

FIG. 13 represents various steps making it possible to calculate the successor nodes on the basis of an entry of the sliding window of “tokens”.

The method described in FIG. 13 comprises, for example, the steps described hereinafter. When a token arrives there are two possibilities:
1) the token is an entry of the dictionary, it is then recognized by the dictionary,
2) the token is not recognized by the dictionary.

The aim is to calculate for a current node N, the set of new nodes reachable by an entry E of the sliding window.

If the entry E is an entry of the dictionary, 30, a search, 31, is made for the nodes which can be reached by E in the transducer of the codes (grammatical, syntactic, semantic and flexional) of node N and, 32, in the transducer of the lemmas of node N. All these nodes which can be reached are added to the list L.

If the entry E is not an entry of the dictionary, a search, 33, is made for the nodes that can be reached by E in the transducer of the inflected forms of node N and they are added to the list L.

### Application of the Grammars to the Sliding Window of Tokens

The local grammars are decomposed, for example, in two ways:
the extraction-only grammars (represented by finite-state automata) which are executed in parallel,
the rewrite grammars (represented by transducers) which are applied in a sequential manner.
   Diagram 14 illustrates the use of the rewrite grammars (or transformation) and extraction grammars on streams of tokens and the dictionary entries.

### Extraction Grammar

The extraction grammars 42i use the previously defined flow of tokens and of the recognized entries of the dictionary 40 to detect a set of tokens which recognize an automaton.

For this purpose, use is made of a list of potential extraction candidates denoted P which contains the following elements:

the index of the next node to be tested,

the position of the next token expected,

the original position of this candidate.

These information makes it possible to detect whether or not a new token “completes” a potential recognition by looking to see whether its position is the one expected and whether it validates one or more transitions.

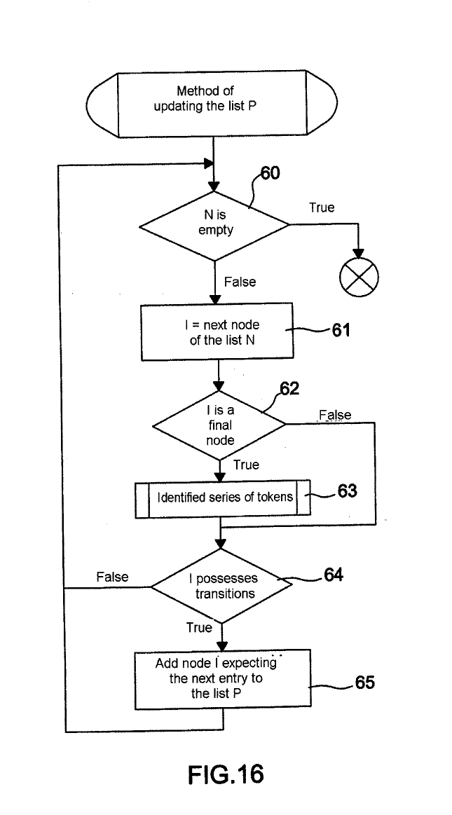

An exemplary sub-method making it possible to update the potential recognition and to detect the complete “matches” is described in FIG. 15, which itself uses a sub-method for updating the list of potential clients, the steps of which are detailed in FIG. 16.

FIG. 15 represents an example of steps making it possible to update the potential recognition and to detect the complete recognition.

Let P be the list of potential extraction candidates and Q an empty list, A an automaton obtained from a n extraction grammar and T an entity.

For all the potential extraction candidates N of the list P, a search is made for the nodes that are accessible from node P using the entry T by the method of searching for the successor nodes described in FIG. 13. All the accessible nodes are then added to the list Q using the list updating method described below, 51, 52, 53.

Once the list P has been fully traversed, a search is made for the nodes accessible from the original node of the grammar using the entry T by the method of searching for the successor nodes, FIG. 13. All the accessible nodes are then added, 54, 55 to the list Q using the list updating method described in relation to FIG. 16. The elements of the list Q are added to the list P.

The updating method described in FIG. 16 comprises notably the following steps:
let P be the list of potential extraction candidates, N the list of nodes that can be reached,
for all the nodes I identified as being accessible by the preceding method, 61, 62, if I is a final (or terminal) node of the grammar, 63, then this is an occurrence of the extraction grammar (a recognition). If I possesses transitions to other nodes, 64, I is added expecting the next entry to the list P, 65.

The application of the dictionaries makes it possible furthermore to detect compound entities consisting of several tokens. This is the reason why the module for searching in the dictionaries informs the grammars that a position can no longer be reached and that it is henceforth impossible to receive data at this position. The search module dispatches, for example, a message to the following module which relays it in its turn to the sub-module (when sequential grammars are used).

The set of possible set of tokens recognizing the longest automaton has therefore been successfully recovered with an approach enabling potential candidates to be rapidly added/removed.

The selection of the set of tokens recognizing the longest automaton or using another criterion such as the priority of one grammar over another requires only a linear passage over the set of tokens identified.

### Rewrite Grammar

The rewrite grammars operate in the same manner as the extraction grammars, except that each set of tokens identified requires a partial or total modification of the tokens involved.

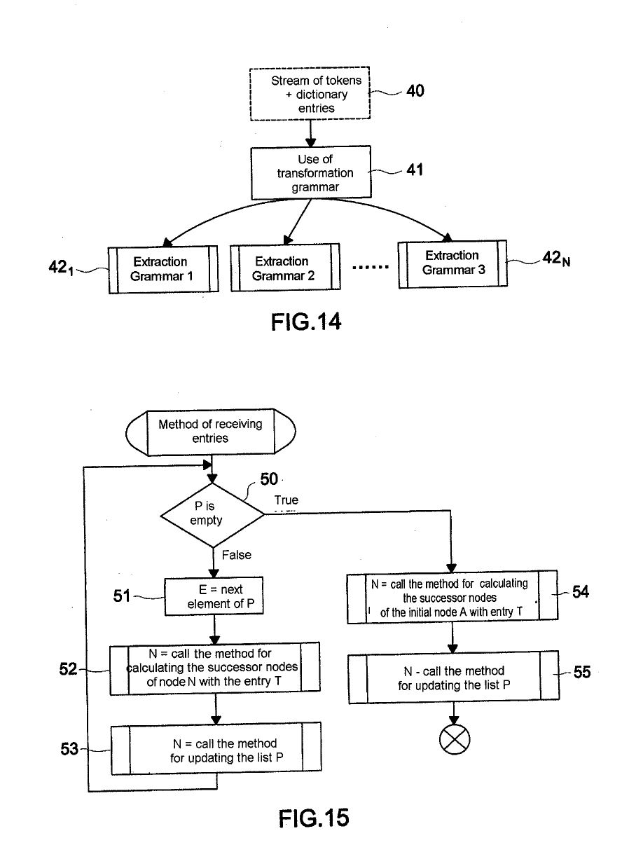

The operating procedure, according to the invention, for this type of grammar consists notably in storing the result directly in the window of tokens. Each rewrite grammar has its own window which will be transmitted to the following grammars in the processing chain, as shown diagrammatically in FIG. 14.

There are two types of execution possible for these grammars:
rewriting while preserving the largest set of tokens identified, this is typically the case for a grammar for recognizing sentences which adds a token at the end of each sentence,
identification of all the set of tokens identified to fill a database for example (conversion of text into digital data).
   Identification of All the Set of Tokens which Recognizes a Transducer for Transformation into Structured Data

In this case, each element of the list of potential candidates P is furnished with a list of references to the transformations to be applied to the tokens.

We can then apply a transformation by a transducer whose input alphabet comprises alpha-numerical characters and whose the output alphabet comprises numerical characters (each integer corresponding to a given class). Said transducer will be applied so as to return to qualitative data and thus transform the text into structured data.

Rewriting while Preserving the Largest Set of Tokens Recognized

This implementation is used during the application of an end-of-sentence recognition grammar.

The largest recognized set of tokens may correspond:

either to the end of a sentence (the end-of-sentence token is thus added),

or to a disambiguation (for example “M. Example” does not correspond to the end of a sentence).

The result of this rewrite is used by other grammars. It is therefore necessary to be capable of making modifications to a stream of tokens. Accordingly, we decide to store the results of the “matches” in the window of tokens, this makes it possible to:

render this rewrite transparent for the following grammars,

select the largest set of recognized tokens easily: it suffices to look at the existing replacements and to preserve the largest.

### Application of the Grammars in Parallel

The use of detection grammars (compiled under automaton form) in parallel is allowed innately by the architecture. Specifically, it suffices to provide the stream of tokens exiting of previous analysis to several other grammars at the same time so as to obtain parallelism at the extraction level.

Taking the case of the extraction of named entities, we apply a transducer for identifying sentences (provided from a rewriting grammer) then we provide this result to the different automatons obtained from extraction grammars (for example place, date, organization, etc.). The same parallelism as that described in FIG. 14 is thus obtained.

### Priorities of the Grammars

According to a variant implementation of the invention, the method implements priority rules or a statistical scoring on the results of the extraction grammars.

Thus, if we have N grammars, knowing that the grammar Gi (i belongs to 1 . . . N) takes priority over the grammars G1 . . . G(i−1), the procedure consists in using in a parallel or sequential manner the N automatons obtained by compiling grammars in order to extract the set of all tokens which recognize at least one of the N automatons and preserve only the “match” of highest priority when there is an intersection between two set of tokens, when the common tokens exist. Depending on the applications, it will be possible to select:

the set of tokens recognizing the automaton of highest priority for each sentence,

one or more set of tokens recognizing the automaton per sentence knowing that there is no intersection between them,

a score per sentence, the score being defined on all the set of tokens recognizing the automaton in this sentence.

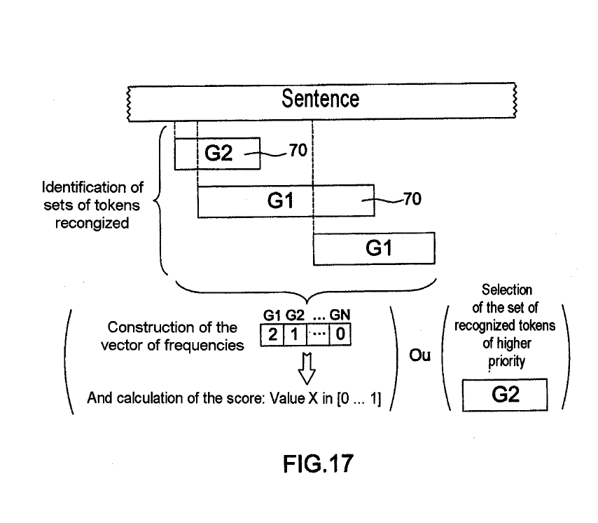

FIG. 17 illustrates an example of managing the priority between two grammars G1, 70, and G2, 71, (G2 taking priority over G1) via a procedure for scoring or for selecting the set of tokens recognizing the automaton of higher priority when there is overlap.

### Disambiguation

The method can also comprise a step, the function of which is notably to resolve ambiguity “disambiguation” in a language (for example to detect the negation in a sentence). For this purpose, each extraction grammar is separated into two parts:

the extraction grammar, 72, as such,

one or more extraction grammars making it possible to resolve an “ambiguity”, 73, and making it possible to define “counter examples”.

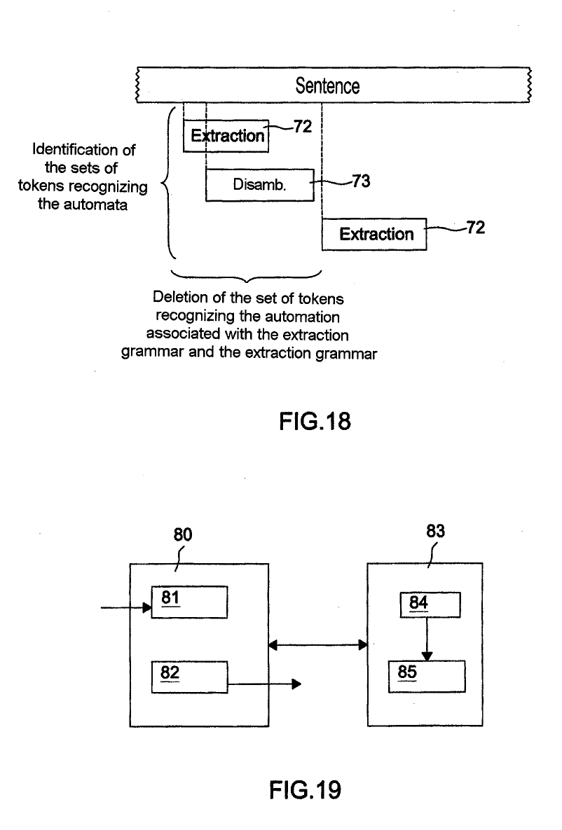

It then suffices to simply extract all the set of tokens recognizing said automatons (obtaining by compiling these) grammars in parallel and to delete the set of tokens recognizing the automaton associated to the extraction grammer 72 and the extraction grammer to take up, as shown by the diagram of FIG. 18.

FIG. 19 represents an exemplary use of the method according to the invention in an email messaging server, the content of whose arriving or incoming messages is analyzed, information is extracted from the message received by the method, 83, by executing the method steps detailed above, so as to determine the most suitable department of a company for dealing with it (for example, marketing, accounts, technical) and transmits it, 84, to the appropriate department to deal with it.

It will be readily seen by one of ordinary skill in the art that the present invention fulfils all of the objects set forth above. After reading the foregoing specification, one of ordinary skill in the art will be able to affect various changes, substitutions of equivalents and various aspects of the invention as broadly disclosed herein. It is therefore intended that the protection granted hereon be limited only by definition contained in the appended claims and equivalents thereof.

1. A method for extracting information from a data file comprising:
a first step wherein the data are transmitted to a device adapted to convert the data in the course of a first step into elementary units, the elementary units being transmitted to a second step of searching in the dictionaries and a third step of searching in grammars transformed in transducers or automatons, wherein, for the conversion step, a sliding window of given size is used, the data are converted into elementary units as and when they arrive in the service and the elementary units are transmitted as and when they are formed to the step of searching in dictionaries, then to the step of searching in the grammars.

2. The method as claimed in claim 1, comprising a step of generating a subset of the dictionary comprising the following steps:
recovering all the transitions of the transducer/automatons compiled from the grammars which refer to the dictionary (lemmas, grammatical codes, semantically codes),
compiling all the transitions, and
selecting the dictionary entries recognizing at least to one of these transitions.

3. The method as claimed in claim 2, wherein the step of compiling the transitions into a transducer comprises the following steps:
the first step includes in extracting, from all the grammars used, the set of the grammatical, semantic, syntactic and flexional codes contained in each of the transitions of the grammars, then,
the second step in constructing an automaton whose input alphabet consists on alpha-numerical characters which associates a unique integer with each code.

4. The method as claimed in claim 1, comprising a step of constructing an optimal sub-dictionary comprising the following steps: for each entry E of a dictionary D, a check is carried out to verify whether the entry E recognizes at least one of the transitions of transducers/automatons compiled from the grammers.

5. The method as claimed in claim 4, wherein the transition comprises lemmas, or grammatical codes, of semantics.

6. The method as claimed in claim 1, wherein use is made of a local grammar on the sliding window of the tokens, the grammar being compiled under an automaton form if grammer is an extraction grammer or under a transducer form if grammer is a rewriting grammar.

7. The method as claimed in claim 1, wherein it uses compiled grammars, a grammar being defined by a finite-state automaton or a transducer, the compilation step comprising:
the deletion of the empty transitions,
the decomposition of the transitions into transducers whose input alphabet consists on alpha-numerical characters, said alpha-numerical characters representing the lemmas and the flexions.

8. The method as claimed in claim 7, wherein the step of deleting the empty transitions of an automaton A composed of several nodes comprises the following steps: for all the nodes N of the automaton A, for all the transitions T from node N to a node M,
if the transition T is an empty transition, and if M is a final node, then the transition T is deleted and all the transitions which have M as starting node are duplicated while putting N as new starting node,
if the transition T is an empty transition and M is a final node, then T is deleted and all the transitions which have N as destination node are duplicated while putting M as new destination node.

9. The method as claimed in claim 8, wherein a transition from a node to N other nodes is defined by a set of three transducers: the transducer of the lemmas, the transducer of the inflected forms, the transducer of the grammatical, syntactic, semantic and flexional codes.

10. The method as claimed in claim 8, wherein the calculation for a current node of the set of new nodes that can be reached by an entry E of the sliding window of tokens comprises the following steps:
if the entry E is an entry of the dictionary, a search is made for the nodes which can be reached by E in the transducer of the codes of node N and in the transducer of the lemmas of node N and the nodes that can be reached are added to a list L,
if the entry E is not an entry of the dictionary, a search is made for the nodes that can be reached by E in the transducer of the inflected forms of node N and they are added to the list L.

11. The method as claimed in claim 1, wherein an extraction grammer uses the series of tokens and of entries of the dictionary to detect the identifications in an automaton/transducer, and in that use is made of a list of potential extraction candidates P including the following elements: the index of the next node to be tested, the position of the next token expected, the original position of this candidate.
